(19) United States
(12) Patent Application Publication
(10) Pub. No.: US 2019/0264337 A1
(43) Pub. Date: Aug. 29, 2019

(54) Production of Functionalised Graphene

(71) Applicant: The University of Manchester, Manchester (GB)

(72) Inventors: Robert Dryfe, Manchester (GB); Ian Kinloch, Manchester (GB); Andinet Ejigu, Manchester (GB)

(73) Assignee: The University of Manchester, Manchester (GB)

(21) Appl. No.: 16/333,064

(22) PCT Filed: Sep. 15, 2017
(86) PCT No.: PCT/EP2017/073314

§ 371 Date: Mar. 13, 2019

(30) Foreign Application Priority Data
Sep. 16, 2016 (GB) 1615820.6

(51) Int. Cl. C25B 1/00; C25B 11/12

(52) U.S. Cl. CPC C25B 1/00; H01G 11/86; C25B 11/12

(57) ABSTRACT

A method for the production of functionalised graphene and/or functionalised graphite nanoplatelet structures having a thickness of less than 100 nm in an electrochemical cell from graphite using a diazonium (R—N2+) species. The graphite is exfoliated and contemporaneously functionalised.

This application claims priority from GB1615820.6 filed 16 Aug. 2016, the contents and elements of which are herein incorporated by reference for all purposes.

The invention relates to methods of producing functionalised graphene and related functionalised graphite nanoplatelet structures in an electrochemical cell.

### BACKGROUND

Professors Andre Geim and Konstantin (Kostya) Novoselov first reported the isolation of graphene in 2004 at the University of Manchester. Graphene immediately attracted interest owing to its highly desirable physical and electronic properties.

Various methods have since been used to prepare graphene in monolayer and few layer forms. These include electrochemical exfoliation of a graphitic electrode. For example, in WO2012/120264 Dryfe and Kinloch describe a method of producing graphene by electrochemical insertion of alkylammonium cations into graphite.

In WO2013/132261 a process in described in which double intercalation of graphite occurs with metal and organic ions. See also [Abdelkader, 2014].

A yet further electrochemical method, described in WO2015/019093, uses solvent-free ionic electrolytes where the electrolyte is selected from (i) an ionic liquid; (ii) a deep eutectic solvent; and (iii) a solid ionic conductor.

However, the processability of graphene for variety of applications greatly hampered by its insolubility in most common low boiling point solvents. Covalent functionalisation is considered as one of the way for enhancing the solubility of graphene. Functionalisation may also be useful for altering the electronic properties of the material.

Most work to date has been focused on functionalisation of pre-made graphene. For example, Sun et al. have reported the chemical functionalisation of thermally expanded graphite, which was then sonicated to cause exfoliation [Sun, 2010]. This protocol was shown to enhance the solubility of the graphene in N,N′-dimethylformamide.

Englert et al. reported the bulk functionalisation of chemically exfoliated graphene with 4-tert-buytlbenzene diazonium/4-sulfonylphenyldiazonium chloride [Englbert, 2011]. The functionalisation prevented graphene aggregation and improved its solubility in chloroform.

Zhong and Swager have reported a method in which they first electrochemically intercalated Li⁺ and tetrabutylammonium ions (TBA) in to graphite in a two stage process in propylene carbonate electrolyte (intercalated Li⁺ ions are thought to undergo ion exchange with the larger TBA ions in the second step).

The resultant expanded graphite was then immersed to electrolyte containing 4-bromobenzenediazonium tertrafluoroborate and electrochemically functionalised. The expanded functionalised graphite was then cut with scissors and sonicated [Zhong, 2012].

### SUMMARY OF THE INVENTION

The invention provides a convenient contemporaneous electrochemical functionalisation and exfoliation of graphite to afford edge-functionalised graphene.

In a first aspect, the invention provides a method for the production of functionalised graphene and/or functionalised graphite nanoplatelet structures having a thickness of less than 100 nm in an electrochemical cell, wherein the cell comprises:
(a) a negative electrode which is graphitic;
(b) a positive electrode; and
(c) an electrolyte which is ions in a solvent and contains a diazonium species;
   wherein the method comprises passing current through the cell to:
(i) effect electrochemical reduction of the diazonium species to produce a functionalising species which undergoes a grafting reaction at the negative electrode; and
(ii) intercalate ions into the negative electrode to effect exfoliation;
   wherein (i) and (ii) occur contemporaneously.

The negative electrode is the electrode held at the most negative potential out of the two electrodes. A reference electrode may also be used.

In other words, the invention provides a method of producing functionalised graphene and/or functionalised graphite nanoplatelet structures having a thickness of less than 100 nm in an electrochemical cell.

The diazonium species undergoes an electrochemical reduction, liberating nitrogen gas and a reactive moiety that is grafted to the layers of the graphitic electrode and/or nascent graphene and graphite nanoplatelet structures. In other words, the diazonium species may be termed R—N₂⁺, which undergoes reduction to a functionalising species R. (a radical species), evolving nitrogen gas. R⁺ then grafts to the edge of the carbonaceous sheets. The term grafting reaction refers to the covalent attachment of substituent groups to the sheets. The reaction is also termed “covalent decoration” in the art.

The inventors observed that the grafting reaction occurs primarily at the edge of the graphene sheets, leading to edge-functionalised graphene and/or edge-functionalised graphitic nanoplatelets having a thickness of less than 100 nm. This edge-functionalisation, as opposed to basal plane functionalisation, is advantageous

Importantly, the intercalation (leading to exfoliation) and the functionalisation occur contemporaneously. In other words, the intercalation, exfoliation and grafting reaction occur in a single process step, during one application of potential difference (voltage) through the cell. There is no need to removal the potential difference, or indeed alter the potential difference, between the electrodes.

Similarly, there is no need to remove the negative electrode at any point during the intercalation, exfoliation and grafting reaction, for example to add further reagents to the cell.

As described herein, advantageously the inventors have found that a graphitic electrode may be intercalated, exfoliated and functionalised in a single step.

This means that the graphitic negative electrode (starting material) may be selected from natural graphite and synthetic graphite. In this respect, the invention differs from the method described by Zhong and Swagger which introduces functionalisation to an expanded electrode, which has already undergone two separate intercalation steps [Swagger, 2012].

In other words, the invention provides a method for the production of functionalised graphene and/or functionalised graphite nanoplatelet structures having a thickness of less than 100 nm in an electrochemical cell, wherein the cell comprises: (a) a graphite electrode which is the negative electrode; (b) a positive electrode; and (c) an electrolyte which is ions in a solvent and contains a diazonium species; wherein the method comprises passing current through the cell to: (i) effect electrochemical reduction of the diazonium species to produce a functionalising species which undergoes a grafting reaction at the negative electrode; and (ii) intercalate ions into the negative electrode to effect exfoliation.

Graphite refers to a material which is not expanded through intercalation or other means. In other words, the average interlayer distance is less than 0.5 nm, for example about 0.335 nm.

As described herein, advantageously the inventors have found that a graphitic electrode may be intercalated, exfoliated and functionalised in a single step, at a single applied potential.

Accordingly, in a further aspect the present invention provides a method for the production of functionalised graphene and/or functionalised graphite nanoplatelet structures having a thickness of less than 100 nm in an electrochemical cell, wherein the cell comprises: (a) a negative electrode which is graphitic; (b) a positive electrode; and (c) an electrolyte which is ions in a solvent and contains a diazonium species; wherein the method comprises passing current through the cell to:
(i) effect electrochemical reduction of the diazonium species to produce a functionalising species which undergoes a grafting reaction at the negative electrode; and
(ii) intercalate ions into the negative electrode to effect exfoliation;
   wherein (i) and (ii) occur at a single applied potential.

In some cases, the negative electrode is graphite foil.

In some cases, the single applied potential difference is less than |3.0 V|. For example, it may be between −2.5 V and −3.0 V. The single applied potential is applied for a duration of time, which may be, for example, between 1 and 6 h. In some cases, the applied potential does not vary by more than ±1 V during the duration of time.

The electrolyte is suitably an organic solution, but may in some embodiments be an ionic liquid. Suitable organic solvents include, but are not limited to, dimethyl sulfoxide (DMSO), N,N-dimethylformamide (DMF), or N-methyl-2-pyrrolidone (NMP).

Interestingly, the diazonium functionalisation aids the exfoliation, so that even ions normally too small to exfoliate graphite to produce graphene and graphitic nanoplatelet structures may be used, for example lithium ions, without the inclusion of a further intercalating species.

The inventors have demonstrated that the process of the reaction may be performed using an electrolyte which is a solution of lithium ions, a solution of caesium ions, or a solution of tetraalkylammonium ions, although it will be appreciated that the invention is not limited to those ions. Suitable cations therefore include lithium, caesium and tetraalkylammonium.

In some cases, there is substantially only one type of cation in electrolyte (other than the diazonium species which is dissolved in the electrolyte and is typically a cation). Substantially in this context means at least 90 mol % of the cations, preferably at least 95%, more preferably at least 97%. In some cases, there is only one type of cation in electrolyte (other than the diazonium species).

As described herein, the inventors have found that caesium ions are attractive intercalating species. The intercalation density of caesium is thought to be similar to that of lithium, but the radius of caesium ions is a good size match for the interstitial distance between the sheets of graphite. Interestingly, caesium may be used to exfoliate graphite when it is the sole cation in the electrolyte without any functionalisation.

Accordingly, in some cases, the intercalating species is caesium ions. The caesium ions may be provided in an organic solvent. Preferably, the caesium ions are provided in an organic solvent such as DMSO, alkyl carbonate, DMF, or NMP; more preferably DMSO, DMF, or NMP.

In other words, the electrolyte may be a solution of caesium ions (for example, a solution of a caesium salt such as CsClO₄) in an organic solvent.

In a further aspect, the invention provides a method for the production of graphene and/or graphite nanoplatelet structures having a thickness of less than 100 nm in an electrochemical cell, wherein the cell comprises:

(a) a negative electrode which is graphitic;
(b) a positive electrode which may be graphitic or another material; and
(c) an electrolyte which is ions in a solvent comprising caesium ions;
and wherein the method comprises the step of passing a current through the cell.

Suitably, the negative electrode is selected from highly ordered pyrolytic graphite, natural graphite and synthetic graphite.

In some cases, the method is carried out at a temperature from 20° C. to 100° C. Preferably, the method is carried out below 50° C., for example, at room temperature.

In some cases, the graphene or graphite nanoplatelet structures having a thickness of less than 100 nm are separated from the electrolyte by at least one technique selected from:

(a) filtering;
(b) using centrifugal forces to precipitate the graphene or graphite nanoplatelet structures; and
(c) collecting the graphene or graphite nanoplatelet structures at the interface of two immiscible solvents.

As exemplified herein, the caesium ions may be provided as an organic solution of CsClO₄. For example, the caesium ions may be provided as a solution in DMSO.

### DETAILED DESCRIPTION

Embodiments and experiments illustrating the principles of the invention will now be discussed with reference to the accompanying figures.

### FIGURES

FIG. 1 shows cyclic voltammograms recorded at HOPG electrode in 0.1 M CsClO₄ in DMSO under N₂ atmosphere containing (A) 1 mM NBD and (B) 1 mM BBD. In each case, the potential was swept between −1.8 and −0.3 V from an initial potential of −0.3 V at 100 mV s⁻¹. The dashed line in each case shows the data obtained in the absence of diazonium species and corresponds to the right axis while the solid line shows the data obtained in the presence of diazonium species and corresponds to the left axis.

FIG. 2 shows reactions that represents the electrochemical reduction of nitrobenzenediazonium species (NBD) cations at a graphite electrode and the subsequent grafting and reduction steps.

FIG. 3 shows UV-visible spectra recorded after applying −4.0 V to isomolded graphite working electrode at indicated time in solution containing 40 mM bromobenzenediazonium (BBD) in 0.3 M CsClO₄ in DMSO.

FIG. 4 shows representative Raman spectra of in situ electrochemically exfoliated and functionalised graphene sheets with various concentrations of (A) BBD (bottom to top graphite, electrochemically exfoliated graphene, 20 mM, 40 mM and 100 mM) and (B) NBD (bottom to top graphite, electrochemically exfoliated graphene, 1 mM, 40 mM and 100 mM).

FIG. 5 shows (A) Wide-scan XP spectrum of electrochemically exfoliated graphene, G-NBD and G-BBD. (B) High-resolution XP spectrum of G-NBD in the N1s region and (C) High-resolution XP spectrum of G-BBD in the B3p region. All peak positions were charge-corrected by setting the binding energy of the C 1s signal to 285 eV.

FIG. 6 shows SEM images of G-NBD that were obtained by electrochemical exfoliation of graphite at −4.0 V vs Ag wire in 40 mM NBD and 0.3 M of CsClO₄ in DMSO (A) dilute dispersion deposited on Si/SiO₂ wafer and (B) restacked films deposited on Si/SiO₂.

FIG. 7 shows (A) TEM image of electrochemically exfoliated graphene flake, (B) TEM image of 40 mM G-NBD, (C) AFM image of electrochemically exfoliated graphene and (D) AFM image of 40 mM G-NBD.

FIG. 8 shows typical UV-vis absorption spectra of (A) 100 mM G-NBD dispersed at indicated solvent/s (B) G-NBD dispersion in water/IPA (1:1 v/v), (C) 100 mM GBBD dispersed at indicated solvent/s and (D) G-BBD dispersion in water/IPA (1:1 v/v). In each case, the functionalised graphene was diluted by a factor of five before measurement.

FIG. 9 shows (A) cyclic voltammograms recorded at 100 mV s⁻¹ in 6.0 M KOH (aq) using symmetrical coin cells constructed from indicated samples. The voltage was swept between 0.0 V to 1.0 V (B)) CVs obtained at 40 mM G-NBD coin cells in 6.0 M KOH at (from top to bottom) 100, 85, 60, 45 and 20 mV s⁻¹ between 0.5 V (initial potential) and 1.3 V (C) charge-discharge curve obtained at indicated electrodes at 0.5 A g⁻¹.

FIG. 10 shows a representative Raman spectrum of G-AQD (solid line) as compared to graphite (dotted line).

FIG. 11 compares the cyclic voltammograms for graphene (inner curve) and AQD (outer curve).

FIG. 12 shows cyclic voltammograms recorded at HOPG electrode in 0.1 M CsClO₄ in DMSO under N₂ atmosphere containing 15 mM AQD at 100 mV s-1. The potential was swept between −1.8 and 0.2 V from an initial potential of 0.2 V.

FIG. 13 shows a schematic illustration G-AQD.

### DIAZONIUM REACTION

Diazonium functionalisation of graphene is attractive owing to its versatility, reaction simplicity and high reactivity towards sp² hybridised carbon centres. The diazonium species readily generates a radical, for example, an aryl radical upon interaction with electron rich surfaces. The radical then rapidly reacts with the sp²-hybridized C-atoms.

The following scheme demonstrates the reaction steps for the nitrobenzenediazonium species (NBD).

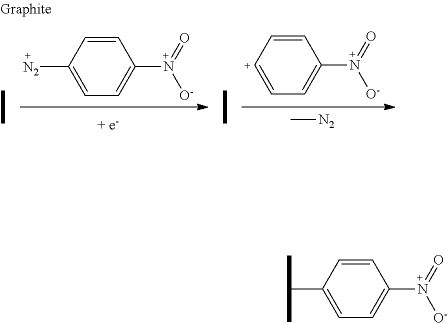

It will be understood that, as used herein, the term “diazonium species” refers to the molecular entity bearing an —N₂ group, typically represented as —N⁺≡N although other tautomeric forms may be represented (for example ═N⁺═N⁻). The diazonium species is suitably provided as a salt, which may be referred to as a diazonium salt, the salt comprising the diazonium species and a counter ion.

It will be appreciated that other suitable diazonium species, which are not necessarily benzene based, may be used. Any suitable R—N₂⁺ species may be used. For example, R may be optionally substituted alkyl, alkenyl, aryl or heteroaryl.

Suitably, R is optionally substituted aryl or heteroaryl. Aryl may refer to C₆₋₂₀ ring systems, for example C₆₋₁₀ ring systems such as phenyl and napthphyl. Aryl includes quinone moieties, for example anthraquinone. Heteroaryl may refer to C₅₋₂₀ ring systems containing one or more heteroatoms, for example, C₅₋₆ ring systems containing one or more heteroatoms.

For example, R may be optionally substituted phenyl.

For example, R may be optionally substituted anthraquinone, for example R may be unsubstituted anthraquinone.

In other words, R—N₂⁺ may be anthraquinone-1-diazonium, also referred to as AQD.

Optional substituents may include halogen (F, Cl, Br, I), OH, NO₂, CN, C₁₋₆alkyl (for example Me), C₂₋₆alkenyl, C₁₋₆ haloalkyl (for example, CF₃, CCl₃), COOH, SO₃H. Preferred optional substituents may include Cl, Br, NO₂, CN, CF₃, CCl₃, and SO₃H.

Optionally the functional group may undergo subsequent reaction/derivatisation to afford other motifs. This approach takes advantage of the first in-situ functionalization step to produce (predominately) edge-functionalised graphene, from which more complicated motifs can be subsequently added.

It will be appreciated that substituents may increase the stability of the diazonium species and/or provide functionality useful for improving the processability of the graphene and/or provide a handle for further reaction. For example, in some cases, the substituent is halogen or NO₂, for example, Br or NO₂ as exemplified herein.

It will be appreciated that the diazonium species is suitably stable to storage and handling at 0° C., more preferably the diazonium species is stable to handling at room temperatures.

In some cases, the diazonium species is selected from:

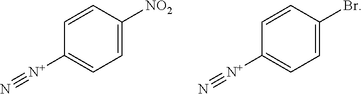 [SMILES: N#[N+]c1ccc([N+](=O)[O-])cc1 ; N#[N+]c1ccc(Br)cc1]

The counterion of the diazonium species may be any suitable cation, for example a halide or borate species. It is known in the art that certain diazonium species may be isolated as tetrafluoroborate salts. These salts often show desirable stability. Accordingly, preferred diazonium species are used as tetrafluoroborate salts.

In some embodiments, the diazonium species is 4-nitrobenzenediazonium (NBD). For example, 4-nitrobenzenediazonium tetrafluoroborate may be used.

In some embodiments, the diazonium species is 4-bromobenzenediazonium (BBD). For example, 4-bromobenzenediazonium tetrafluoroborate may be used.

In some embodiments, the diazonium species is anthraquinone-1-diazonium (AQD). For example, anthraquinone-1-diazonium chloride may be used.

### Preferential Edge Functionalisation

The inventors observe that the process is highly selective for edge functionalisation, and that little, if any, functionalisation is introduced onto the basal plane of the obtained graphene sheets.

Without wishing to be bound by any particular theory, the inventors attribute this firstly to a thermodynamic preference for edge functionalisation resulting from the electron/charge distribution in the sheets and, secondly, to the fact that it appears that functionalisation occurs is underway before exfoliation of the bulk material begins. As graphene sheets (already edge-functionalised) calve off the cathode, functionalisation continues to be preferred at the electrode material.

The predominantly edge functionalised material thereby offers the advantages of improved solubility and processability without sacrificing the desirable electronic and physical properties associated with largely defect-free graphene sheets.

Importantly, the inventors observe that, contrary to what may be expected, grafting substituents to the edges of the individual sheets does not significantly impact the intercalation of ions and other species to cause/assist exfoliation. Without wishing to be bound by any particular theory, the inventors speculate that the edge functionalisation may indeed assist separation of the individual layers of the graphite, causing a limited degree of expansion that may even assist intercalation of cationic species.

For example, in the case of exfoliation and functionalisation using NBD and Cs⁺, the inventors observed an increase in over-potential of only 0.3 V compared to exfoliation using Cs⁺ in blank electrolyte, with no apparent loss of intercalation.

Indeed, the inventors think that the functionalisation of the edges of the layers may also assist the exfoliation process through generation of N₂ gas (a by-product of the reaction) at the electrode.

For example, although Cs⁺ alone has been demonstrated to exfoliate graphene in an electrochemical cell, the inventors believe that the evolving gas may assist sheet separation away from the electrode. The gas may enter the interstitial spaces between the sheets, the van der Waals forces between which are already weakened by the presence of the intercalating species and help to drive the sheets apart. The evolution of the N₂ gas additionally causes turbidity in the vicinity of the electrode, assisting breakaway of exfoliated or partially exfoliated sheets.

Interesting, the inventors have observed that the assistance of the edge functionalisation provides permits even very small intercalation species to be used. For example, Li⁺ is able to intercalate between layers in graphite but does not cause exfoliation to produce graphene. This is attributed to the small size of Li⁺ (only 0.146 nm). The use of a further, larger cation, such as a tetramethylammonium cation is therefore used [Abdelkader, 2014].

However, the inventors have observed that a combination of a diazonium species as described herein with Li⁺ resulted in both functionalisation and exfoliation of the graphitic electrode, producing functionalised few layer graphene. Without wishing to be bound by any particular theory, the inventors attribute this to:
(i) functionalisation helping to prise apart the edges of the layers, and
(ii) the presence of intercalated Li⁺ weakening interstitial forces,
   so that the forces exerted by the evolving N₂ gas are sufficient to effect separation of layers.

Importantly, some degree of intercalation appears necessary. In a control experiment, the inventors performed the electrochemical reaction with NBD but no metal ion (or other intercalating ion, for example, an ammonium species). No exfoliation was observed, despite significant gas evolution as functionalisation occurred.

### Negative Electrode

The negative electrode is graphitic. Both natural and synthetic graphite may be used. In some cases, the electrode is natural graphite. For example, the electrode may be graphite foil or rod. In some cases, the electrode is synthetic graphite.

In some cases, the electrode is isomolded graphite. Isomolded graphite is also referred to as isotropic graphite, isostatic graphite, and isostatically pressed graphite. Isomolded graphite may be preferred because of its uniformity.

In general, any solid graphite electrodes may be used in the methods described herein. In some embodiments, the negative electrode may be of a ladle design to avoid issues with disintegration of the electrode into large pieces. In another embodiment graphite powder is held in a porous fabric, such as a muslin cloth, or in a conductive mesh such as a nickel mesh. In other embodiment, the graphite negative electrode may be held at a liquid-liquid interface. In such an embodiment, the negative electrode may be a liquid metal such as mercury or gallium on which graphite flakes are placed, allowing continual contact with the graphitic material as it is exfoliated into the desired material.

### Positive Electrode

The positive electrode may consist of any suitable material known to those skilled in the art as it does not play a role in the graphene production, other than to provide a counter electrode for the anions. Preferably, the positive electrode is made from an inert material such as gold, platinum or carbon.

When the reaction at the positive electrode generates a gas the electrode surface area is as large as possible to prevent gas bubbles wetting it and/or disrupting the process at the negative electrode. The positive and/or reference electrode may also be placed in a membrane or molecule sieve to prevent undesired reactions in the electrolyte or at either electrode.

In one embodiment, both electrodes can be suitably made from graphite and the potential switched between the two to effect exfoliation and functionalisation at each electrode in turn.

### Cell Potential and Current Density

The working potential of the cell will be at least that of the standard potential for reductive intercalation. An overpotential may be used in order to increase the reaction rate and to drive the cations into the galleries of the graphite at the negative electrode. Preferably an overpotential of 1 mV to 10 V is used against a suitable reference as known by those skilled in the art, more preferably 1 mV to 5 V, more preferably 1 V to 5 V. In some cases, the overpotential is about 4 V. In cells with only two terminals, and no reference, a larger potential may be applied across the electrodes but a significant amount of the potential drop will occur over the cell resistance, rather than act as an overpotential at the electrodes. In these cases the potential applied may be up to 20V or 30V.

Advantageously, the inventors have found that both functionalisation and exfoliation can be achieved at a single potential, effectively in a single step. Accordingly, in some cases the variation in overpotential during the period in which the current is applied is less than ±1 V, for example, less than ±0.5 V.

The current density at the negative electrode may be controlled through a combination of the electrode's surface area and overpotential used.

### Electrolyte

The electrolyte is suitably ions in an organic solvent, but may be in some embodiments an ionic liquid.

Solvents which can be used include (N-methyl-2-pyrrolidone) NMP, alkyl carbonates (such as propylene carbonate), DMSO (dimethyl sulfoxide), DMF (N,N′-dimethyl formamide) and mixtures thereof. In one embodiment, the solvent used has an affinity for graphene or graphite nanoplatelet structures so that the material produced at the electrode is taken away by the solvent. In another embodiment, the solvent has no affinity for graphene or graphite nanoplatelet structures, so that the material produced falls to the bottom of the electrochemical cell, allowing easy collection of the graphene produced.

### Further Method Steps

The functionalised graphene or graphite nanoplatelet structures having a thickness of less than 100 nm produced by the method of the invention may be separated from the electrolyte by a number of separation techniques, including:

(a) filtering;
(b) using centrifugal forces to precipitate the graphene or graphite nanoplatelet structures; and
(c) collecting the graphene or graphite nanoplatelet structures at the interface of two immiscible solvents.

The electrochemically exfoliated graphene or graphite nanoplatelet structures may be further treated after exfoliation. For example, the materials may be further exfoliated using ultrasonic energy and other techniques known to those skilled in the art to decrease the flake size and/or number of graphene layers.

### Operating Temperature

The cell is operated at a temperature which allows for production of the desired material.

The cell may be operated at a temperature of at least 10° C., preferably at least 20° C. The maximum cell operating temperature may be 100° C., and more preferably 90° C., 80° C., 70° C. or 50° C. In some embodiments, the cell may be operated at a temperature of at least 30, 40 or 50° C. The maximum cell operating temperature may be as high as 120° C. The optimum operating temperature will vary with the nature of the solvent. Operating the cell up to the boiling point of the electrolyte may be carried out in the present invention.

### Graphene and Graphite Nanoplatelet Structures

In the present application, the term “graphene” is used to describe materials consisting of ideally one to ten graphene layers, preferably where the distribution of the number of layers in the product is controlled. The method can also be used to make graphite nanoplatelet structures under 100 nm in thickness, more preferably under 50 nm in thickness, more preferably under 20 nm in thickness, and more preferably under 10 nm in thickness. The size of the graphene flakes produced can vary from nanometres across to millimetres, depending on the morphology desired.

In embodiments, the material produced is graphene having up to ten layers. The graphene produced may have one, two, three, four, five, six, seven, eight, nine or ten layers. It may be preferred that the material produced is substantially free of graphene oxide. “Substantially free” means less than 10% by weight, preferably less than 5% by weight, more preferably less than 1% by weight of graphene oxide.

In embodiments, the material produced may comprise at least 10% by weight of graphene having up to ten layers, preferably at least 25% by weight and more preferably at least 50% by weight of graphene having up to ten layers.

The method of the invention produces graphene and/or graphite nanoplatelet structures having a thickness of less than 100 nm. In embodiments, the method produces graphene or graphite nanoplatelet structures having a thickness of less than 100 nm. In embodiments, the method produces graphene and graphite nanoplatelet structures having a thickness of less than 100 nm. In embodiments, the method of the invention produces graphene. In embodiments, the method produces graphite nanoplatelet structures having a thickness of less than 100 nm. The method of the invention may for example produce graphene or a combination of graphene and graphite nanoplatelet structures having a thickness of less than 100 nm.

In embodiments, the method produces more graphene by surface area than graphite nanoplatelet structures having a thickness of less than 100 nm, preferably wherein substantially all material produced by the method is graphene by surface area (wherein at least 90%, preferably at least 95%, more preferably at least 98%, e.g. at least 99% of the material produced by the method is graphene by surface area), such as wherein all material produced by the method is graphene. In embodiments, the method produces more graphene by weight than graphite nanoplatelet structures having a thickness of less than 100 nm, preferably wherein substantially all material produced by the method is graphene by weight (wherein at least 90%, preferably at least 95%, more preferably at least 98%, e.g. at least 99% of the material produced by the process is graphene by weight), such as wherein all material produced by the process is graphene. Thus, in some embodiments, the graphene consists of one to five graphene layers, preferably one to four graphene layers, more preferably one to three graphene layers, for instance one to two graphene layers, e.g. one layer. The graphene produced may therefore have one, two, three, four, five, six, seven, eight, nine or ten layers.

### EXAMPLES

The following examples, including the experiments conducted and the results achieved, are provided for illustrative purposes and are not intended to limit the invention.

Materials and Reagents 4-nitrobenzenediazoniumtetrafluoroborate (97%), 4-bromobenzenediazonium tetrafluoroborate (96%), and anhydrous dimethyl sulfoxide (99.9%) were obtained from Sigma-Aldrich. Anthraqunone diazonium chloride was obtained from BOC sciences, USA. Caesium perchlorate (99%) was obtained from Fisher Scientific. All electrochemical measurements were performed using Autolab potentiostat model PGSTAT302N (Metrohm Autolab, The Netherlands). Iso-molded graphite (>99.95%) rods were purchased from GraphiteStore and graphite foil (99.8%) was obtained from Alfa Aesar. Polytetrafluroethylene was obtained from Omnipore membrane filters (JVWP01300) with pore size of 0.1 μm. Millipore water (18.2 MΩ cm) was obtained from Milli-Q water purification system. Highly oriented pyrolytic graphite (HOPG) ZYB quality was purchased from Micromechanics Ltd (Hong Kong).

### Electrochemistry of Cs⁺ and Diazonium Salt

A freshly cleaved highly oriented pyrolytic graphite working electrode, a Pt mesh counter electrode and an Ag wire reference electrode were used for electrochemical measurements. The potential of an Ag wire was stable within a few mV for over 4 hr. Prior to performing cyclic voltammetry, N₂ gas was bubbled into the electrolyte for 30 min and during electrochemical measurements an atmosphere of N₂ was maintained above the electrolyte. The electrolyte consists of either 0.1 M CsClO₄ and 1 mM 4-nitrobenzene-diazoniumtetrafluoroborate (NBD) in an anhydrous dimethyl sulfoxide (DMSO) or 0.1 M CsClO₄ and 1 mM 4-bromobenzenediazonium tetrafluoroborate (BBD) in DMSO.

### Electrochemical Exfoliation and Functionalisation

Electrochemical exfoliation and functionalisation of graphene were performed using a three electrode setup consisting of an isomolded graphite rod/graphite foil working electrode, a silver wire reference electrode and an isomolded graphite rod counter electrode. The effective area of the working electrode that was exposed to the electrolyte was ˜12 cm².

The electrolyte was prepared by dissolving 0.3 M CsClO₄ and various concentrations (1 mM, 40 mM and 100 mM) of either NBD or BBD in an anhydrous DMSO. Simultaneous electrochemical exfoliation and functionalisation was performed using chronoamperometry by applying a potential of −4.0 V vs Ag wire for 2 hrs under constant stirring. In a similar way, the non-functionalised graphene was exfoliated at the same potential in solution that only contained 0.3 M CsClO₄ in dimethyl sulfoxide. The exfoliated product was then washed with plenty of acetone and ultra-pure water, and dried under vacuum at 60° C. overnight. The functionalised powder was dispersed in desired solvent (water, isopropanol and a mixtures of water and isopropanol alcohol) by sonicating for 30 min. The resulting mixture was centrifuged at 4000 rpm for 30 min, and the supernatant was extracted using pipette without disturbing the residue.

To verify that the experimental set up was independent of cation, 0.3 M of tetraethylammonium tetrafluoroborate was used instead of CsClO₄, and similar result was obtained.

The experimental set up was also repeated with 40 mM NBD and 0.3 M LiClO₄. Once again, a similar result was obtained.

### Characterisation of the Exfoliated Product

Raman spectra were obtained using Renishaw inVia microscope with a 532 nm excitation laser operated at low power of 1 mW with a grating of 1800 I/mm and 100× objective. The sample for Raman measurement was prepared by drop coating the dispersion of graphene on to Si/SiO₂ wafer and dried on hot plate at 100° C. to evaporate the solvent. Scanning electron microscopy (SEM) analysis was carried out using XL30 FEI Environmental scanning electron microscope operated at 15 kV and the sample was prepared by drop coating the dispersion of graphene on to Si/SiO₂ wafer. The samples for AFM measurement was prepared by spray coating the dispersion of graphene on Si/SiO₂. The AFM model was and the AFM operates in tapping mode under ambient conditions. Transmission electron microscopy (TEM) images were recorded using a JEOL 2000FX TEM, operated at 200 kV. X-ray photoelectron spectroscopy (XPS) was performed using a Kratos Axis Ultra DLD spectrometer with a monochromated Al Kα X-ray source (E=1486.6 eV, 10 mA emission), a hemispherical electron energy analyser and a multichannel plate and delay line detector (DLD). The dispersion concentration of graphene was measured using UV-visible spectroscopy using a model DH-2000-BAL (ocean optics). The extinction coefficient of functionalised graphene was determined following the method described by Coleman et al [Hernandez, 2008].

### Membrane Preparation for Supercapacitor Testing

Films of non-functionalised graphene, NBD-functionalised graphene or BBD-functionalised graphene were prepared by filtering a known volume of the dispersions over polytetrafluroethylene (PTFE) using a syringe pump dispenser (New Era Pump Systems, Inc, NY). The membrane was then dried in an air oven at 80° C. for overnight. A coin cell assembly was prepared in standard CR2032 coin cell hardware with symmetrical active materials. The cells were assembled by stacking the two symmetrical membranes back-to-back with the active material contacting the current collector [Bissett, 2015]. A few drops of deoxygenated 6 M KOH (aq) were added to fill the electrode before the coin cell was sealed using a hydraulic crimping machine (MSK-160D). Specific capacitance was calculated using the best practice methods established by Stoller and Ruoff [Stoller, 2010].

### Electrochemistry of Diazonium Salt

The inventors examined if the diazonium species attached to the graphite hinders the intercalation of Cs⁺. It has been previously observed that grafting carbon electrodes with diazonium species passivates the surface and often the grafted surface tends to inactive towards simple redox mediators such as ferrocene and ferricyanide [see, for example, Saby, 1997].

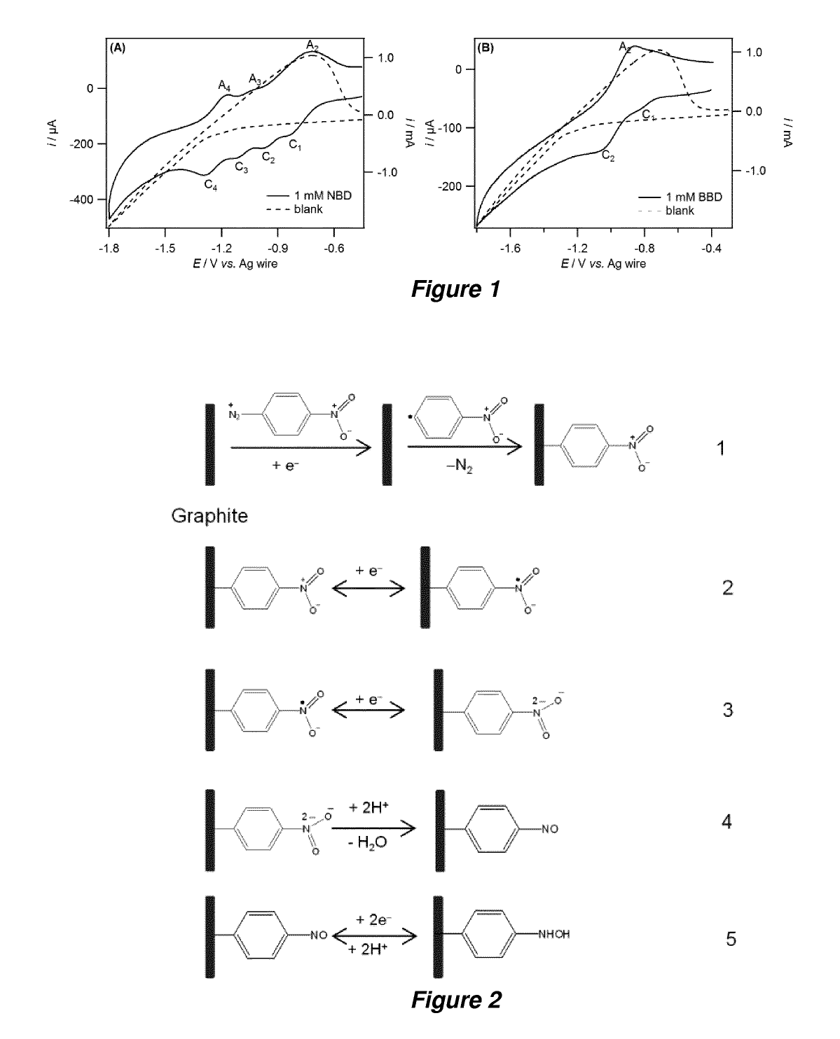

FIG. 1A shows cyclic voltammograms (CVs) recorded under N₂ atmosphere at HOPG with and without NBD. In blank electrolytes (0.1 M CsClO₄ in DMSO), as the potential of the electrode scanned in a negative direction, a cathodic current started to flow at approximately −1.3 V and a broad peak was observed at −3.5 V, and this was due to the intercalation of Cs⁺. A sharp increase in current was seen due to the reduction of DMSO as the electrode potential further scanned negative of −4.0 V.

The CV response containing NBD, in contrast, showed a series of oxidation and reduction processes (FIG. 1B). Scanning the electrode potential in the negative direction yielded four reduction peaks. Peak clipping experiment revealed that C₂, C₃, and Ca were related to A₂, A₃ and A₄ respectively. C₁ was found to be irreversible indicating that the electrogenerated product was unstable and reacted to the surface. C₁ was attributed to the formation of nitrobenzene radical according to Equation 1 (FIG. 2), and this radical is known to be highly reactive towards carbon-based electrodes. See, for example, [Allongue, 1997].

C₂ and C₃ were attributed to the formation of nitro radical and dianion species respectively (Equation 2 and 3 of FIG. 2). Nitrobenzene reduces reversibly in one-electron transfer process to yield a stable radical anion whereas the dianion species is susceptible to rapid protonation in the presence of weak acid. Since the peak current ratio of A₃ to C₃ in the CV is less than ˜0.5, the dianion might be protonated to form unstable species by accepting proton from trace water or from DMSO itself (Equation 4). Bard and Co-worker reported that the dianion can decompose to nitrosobenzene after the loss of hydroxyl ion in the presence of weak acid (isopropyl alcohol) [Smith, 1975]. Compton and co-workers also reported the instability of the dianion species in aprotic room temperature ionic liquid [Silvester, 2006].

The nitrosobenzene formed, after the decomposition of the dianion, can reduce to phenylhydroxylamine via two-electron and two-proton transfer processes in aprotic electrolytes, and to aminophenyl via four-electron and four-proton transfer processes in aqueous system. The current measured due to C₄ is approximately twice that of the current measured due to either C₂ or C₃ suggesting that C₄ is a two-electron transfer process. The inventors therefore attributed C₄ to the formation of phenylhydroxylamine as shown in Equation 5.

Perhaps the most important observation from the CV is that the grafting of the HOPG surface by the nitrobenzene species did not hinder the intercalation of Cs. Its overpotential increased by 0.3 V compared to Cs⁺ intercalation in blank electrolyte. The inventors have therefore demonstrated the possibility of both functionalisation and exfoliation in a single step.

The electrochemistry of 4-bromobenze diazonium (BBD) differs from the electrochemistry of NBD in that only two reduction peaks and one oxidation peak were observed (see FIG. 1B). The first reduction peak (C₁) was due to the formation of bromobenzene radical which rapidly reacts with HOPG surface as discussed previously. C₂ was related to A₂ and it might be due to the reversible one electron transfer to form radical species. The intercalation of Cs⁺ also occurred at the same potential as in the blank electrolyte suggesting that the presence of bromobenzene on HOPG surface did not changed the potential for Cs⁺ insertion.

Diazonium Reaction Progress during Electrochemical Exfoliation Graphite rod or foil was used for simultaneous exfoliation and functionalisation, following the understanding of Cs⁺ and diazonium electrochemistry, at single applied potential. −4.0 V vs Ag was chosen as the potential since at this potential Cs⁺ intercalation occurs at diffusion controlled rate and also at this potential the reduction of diazonium species occurs at very facile rate.

The ionic size of Cs⁺ is 0.338 nm which is similar to the interlayer spacing of graphite (0.335 nm). Moreover, the size of solvated Cs⁺ is expected to be higher than the interlayer distance of graphite. In fact, the Cs—O bond length in DMSO solvated Cs⁺ is 0.306 nm and each Cs⁺ forms solvation with eight DMSO molecules.

During electrolysis, significant gas evolution was detected at the surface of the electrode. The gas evolution was accompanied by the exfoliation of graphite within few minutes of electrolysis.

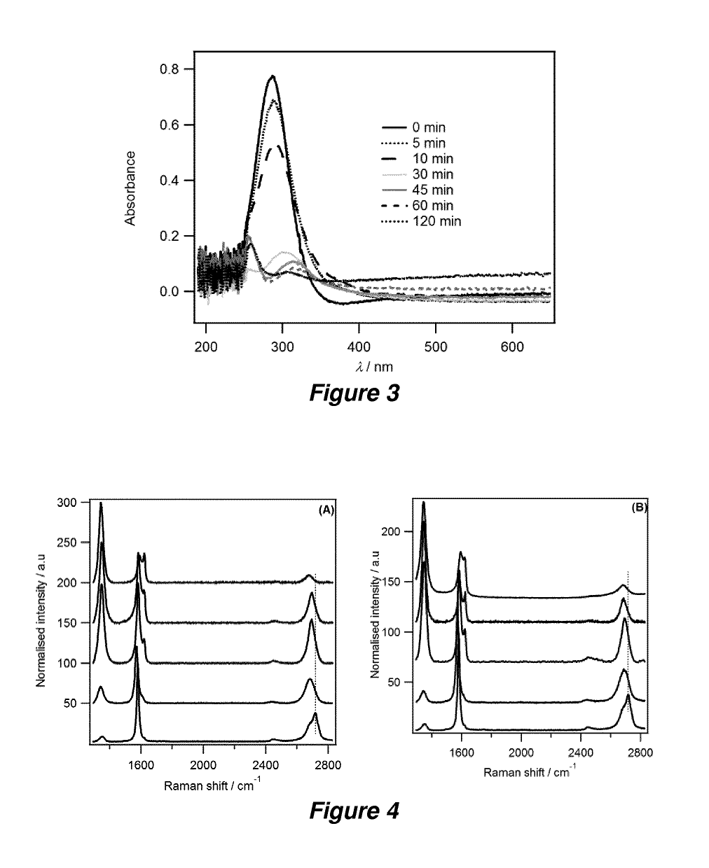

The rate of the diazonium reaction during exfoliation was monitored by UV-vis spectroscopy. FIG. 3 shows the reaction progress of BBD in a solution containing 0.3 M CsClO₄ and 40 mM BBD as a function of electrolysis time (t). A broad absorption peak was observed at 287 nm which was due to the electronic transitions from the diazonium at t=0 [Mu, 2004]. The intensity of this peak decreased gradually as t increased to 10 min and rapidly decreased at t=30 min indicating that 85% of the diazonium already reacted within 30 min of electrolysis. Complete diazonium reaction was realised at t=2 hr. Moreover, a new absorption peak was emerged once t>30 min at 256 nm and a modest constant absorption in the visible light range was also noted. This new absorption peak is likely due to the electronic transition from exfoliated functionalised graphene materials. All in situ electrochemical exfoliation and functionalisation, therefore, were carried out for 2 h.

### Characterisation of the Exfoliated Product

Raman spectroscopy was used to confirm the formation of few layer functionalised graphene and FIG. 4 shows the Raman spectroscopy of functionalised graphene at various diazonium concentrations. For comparison, the electrochemically exfoliated graphene (labelled EEG on the figure) using Cs⁺ in the absence of diazonium is also presented and compared with the Raman spectrum of the starting graphite material. The Raman spectrum of graphite shows two intense peaks at 1579 cm⁻¹ and 2719 cm⁻¹ that correspond to the G band and 2D band respectively. The G band is due to the E_{2g} vibrational mode of sp² hybridised carbon and the 2D band is a second order vibration caused by the scattering of two phonons with opposite wave vectors. An additional small peak is seen at 1349 cm⁻¹ due to the D band and this band is active when there are defects in graphitic materials. Lattice defects can be caused by formation of sp³ hybridisation through covalent chemistry or by the physical defects or edges in sp²-conjugated carbon.

After electrochemical exfoliation in the absence of diazonium, the peak position of the 2D band and the G band shifted by about 33 cm⁻¹ and 8 cm⁻¹ respectively. Moreover, the shape of the 2D peak changed from the typical broad asymmetric shape of graphite to symmetric line shape. This indicates the formation of few layer graphene sheets.

A substantial increase in the intensity of the D band was noted relative to electrochemically exfoliated graphene for the samples that were exfoliated in the presence of diazonium salt. The intensity of the D-band was found to be strongly dependent on the concentration of diazonium salt.

The evolution of the D-band was accompanied by an increase in the intensity of the D′ band at 1614 cm⁻¹. The intensity ratio of the D band to the G band (i_{D}/i_{G}) in electrochemically exfoliated graphene is 0.28 and this value is increased to 2 and 3 respectively when 100 mM NBD and 100 mM BBD are used for in situ functionalisation. It is widely accepted that the intensity ratio of the D band to the G band is a measure of disorder or defect within graphene flakes. It has also been used to characterise the degree of covalent functionalisation by diazonium species [Niyogi, 2010].

Greenwood and co-workers electrochemically functionalised pristine graphene with a range of diazonium salt concentration and they reported an i_{D}/i_{G} of between 0.1 and 3.1 [Greenwood, 2015]. The intensity of the 2D band also decreased and broadened due to the electron withdrawing (p-type doping) nature of nitrogen and bromine. The p-type doping is more evident by the upshift in the peak position of the G band and 2D band with increasing diazonium concentration and this observation is consistent with reported literature [Niyogi, 2010], [Solis-Fernandez, 2015], [Lim, 2010].

The Raman spectra also did not showed any physisorbed diazonium related bands as previous work reported that surface adsorbed non-covalently reacted diazonium molecules usually appeared between 1400 and 1440 cm⁻¹. This suggests the absence of any surface adsorbed non-covalently reacted diazonium molecules and that electrochemical functionalisation exclusively occurred by covalent bonds.

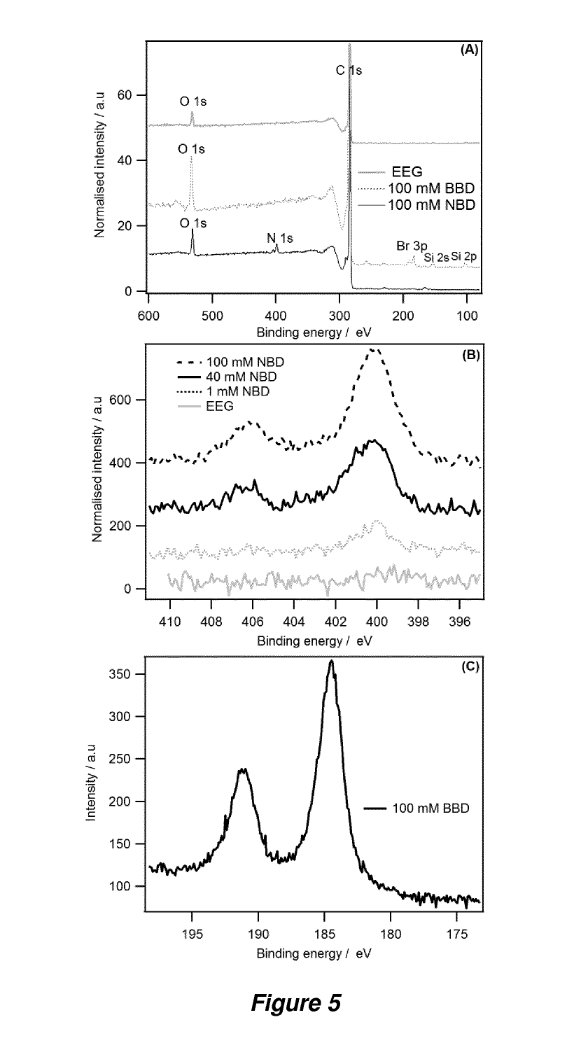

X-ray photoelectron spectroscopy (XPS) was also used to confirm the electrochemical functionalisation of graphene as well as to evaluate its chemical compositions. FIG. 5 displays the wide scan spectrum of electrochemically exfoliated graphene, graphene functionalised with nitrobenzenediazonium (G-NBD) and graphene functionalised with bromobenzenediazonium (G-BBD). In each case, the signal due to C1s and O1s was observed and all peak positions are charge corrected by setting the binding energy of C 1s signal equal to 285 eV. The presence of N1s in G-NBD and Br3p in G-BBD in the survey scan confirms the success of graphene functionalisation with the desired phenyl moieties. Moreover, the atomic concentration of N increased from 0.5% in 1 mM of NBD to 4.8% in 100 mM NBD while the atomic concentration of Br increased from 0.4% in 1 mM BBD to 5.2% in 100 mM BBD.

The high resolution N1s signal only showed one peak at 399.3 eV in 1 mM NBD and previous literature attributed this binding energy position to NH₂ group [Mendes, 2003]. Although our electrochemical analysis indicated that NHOH is the most likely surface moieties at −1.5 V, the NHOH group might undergo further reduction to NH₂ group as exfoliation and functionalisation was carried out at −4.0 V. However, as the concentration of NBD increased to 40 mM and above, a small shoulder peak at 405.6 eV was emerged at the characteristic binding energy of nitrogen as in NO₂ group. The evolution of the NO₂ group depends on the concentration of NBD. In 40 mM NBD, the NO₂ group accounts for 19% and it increased to 29% in 100 mM NBD. The presence of NH₂ group in significant concentration (>70%) in all the samples studied supports the conclusions drawn from the electrochemical analysis of NBD.

However, it should be noted that the existence of NO₂ group may suggest some diazonium functionalisation also occurred in the solution by spontaneous in situ chemical reaction after electrochemical exfoliation.

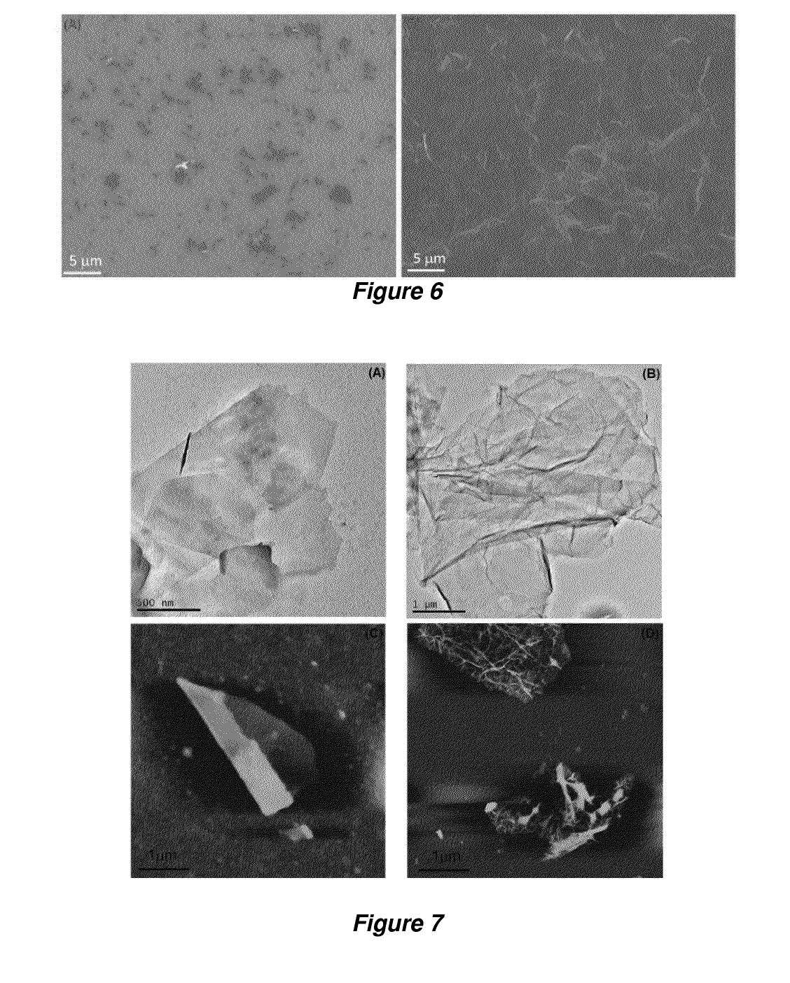

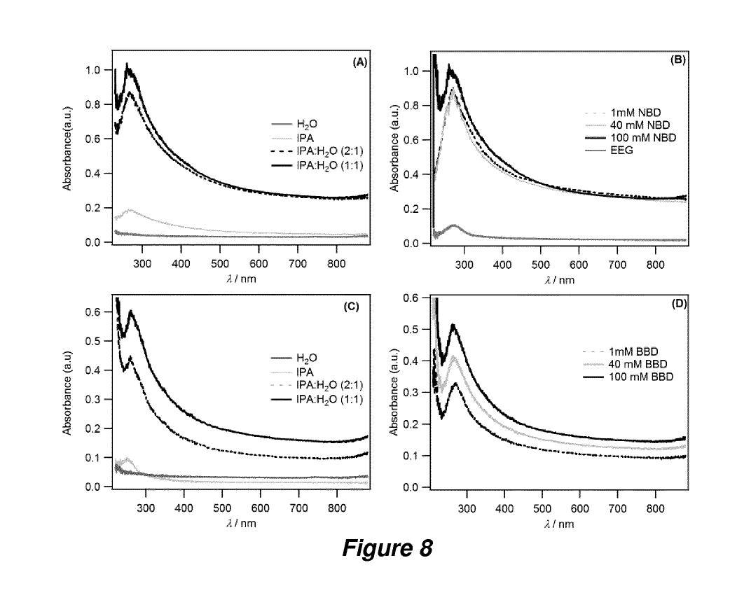

FIG. 6A shows the representative SEM image of functionalised graphene flakes (40 mM G-NBD). The lateral size measurement of 200 flakes indicated that the flake size varies between 0.5 μm and 3.5 μm, and the majority of the flakes are ˜1 μM. There is a clear difference between the morphology of functionalised graphene and non-functionalised graphene as shown in SEM, TEM and AFM images. The functionalised graphene flakes displayed a network of intense wrinkles and ripples all over its surface whereas the non-functionalised graphene flakes exhibited a folded flat surface (see FIGS. 6B and 7). Such observation also noted previously for functionalised graphene and was attributed to the strain generated by an intense functionalisation. Nanoscale wrinkles on graphene sheets reduce restacking between individual sheets, offer fast ion diffusion channels and provide more active sites for catalytic reactions, and is attractive for energy storage devices such as supercapacitors. This feature also provides improved adhesion and better interlocking property within polymer composites.

The measured flake thickness for the non-functionalised graphene using AFM varies between 0.67 nm to 5 nm indicating the formation of monolayer graphene to multilayer graphene. It fluctuates from 1 nm to 12 nm for functionalised graphene because of the substantial wrinkling and functionalisation.

### Dispersibility of Functionalised Graphene

The dispersibility of graphene in solvent is dictated by the match between the surface energy of graphene and the solvent whereas its long term stability determined by the solvents ability to stabilise the graphene sheets via electrostatic repulsion or steric hindrance. Solvents with similar surface energies to that of graphene are considered to be the most efficient solvents for dispersing graphene as the interfacial tension between those solvent and graphene is minimal. Organic solvents like N-methylpyrrolidone and dimethylformamide have been found to be the best solvents for dispersing graphene.

However, these solvents are toxic to multiple organs, limiting their desirability. Furthermore, their high boiling point poses problems for deposition of flake and formation of composite materials. Low boiling point solvents such as chloroform and isopropanol are used for graphene dispersions and exfoliation, but they suffer from poor dispersion stability and exfoliation quality.

In this regard, improved dispersibility in water and low toxic organic solvents play a paramount importance for commercial applications. The solubility of graphene in water is very low because of its strong hydrophobicity while graphene oxide does disperse in water due to its surface functional groups.

The inventors examined the dispersibility of functionalised graphene as described herein in water and isopropanol (IPA) mixtures and compared its dispersibility with unfunctionalised graphene. It should be noted that each sample was intentionally centrifuged at 8000 rpm for 30 min to see the stability of the dispersion, and the supernatant was analysed by UV-vis spectroscopy. It is widely accepted that the concentration of graphene can be estimated using Beer-Lambert low by taking the value of the absorbance at 660 nm (A₆₆₀). FIG. 8 shows UV-visible spectra obtained from a dispersion of G-NBD and G-BBD in water, IPA and water-IPA mixes. Both G-NBD and G-BBD showed low value of A₆₆₀ when dispersed in either neat water or IPA. However, the mixture that contained IPA and water in one to one volume ratio gave the highest value of A₆₆₀ for each sample, indicating that this solvent mix is the best for dispersing G-NBD and G-BBD. Water-alcohol mixtures were used for exfoliation of graphite and in this case the dispersion of graphene found to be much higher in the mixture than either of the individual solvents. The enhanced dispersion was attributed to the modification of Hansen solubility parameters (HSP).

The optimum mass fraction of isopropanol in IPA-water mixture is reported to be 55% for graphene, which is very close to the mass fraction of IPA (˜60%) used in this work.

FIGS. 8A and 8C show that increasing the concentration of water in the dispersion solution had a greater impact on BBD functionalised graphene than NBD functionalised graphene, suggesting that brominated graphene is more polar than nitrogenated graphene. The dispersion of G-BBD found to be strongly dependent on the functionalisation concentration of BBD (FIG. 8D), showing an increase in solubility as BBD concentration increased from 1 mM to 100 mM. By contrast, the solubility of G-NBD found to be independent of NBD concentration: the inventors observed that greater dispersion concentration can be achieved with only 1 mM NBD compared to the dispersion obtained in 100 mM BBD (FIG. 8C).

The absorption coefficient (α) of G-NBD and G-BBD dispersion was determined as per the method given by Coleman et al. [Hernandez, 2008] using IPA/water mixture in 1:1 volume ratio. Each dispersion follows the Beer-Lambert law as the absorbance increases linearly with increasing concentration, and α value of 2978±125 mL mg⁻¹ m⁻¹ for G-NBD and 2853±268 mL mg⁻¹ m⁻¹ were obtained. A range of α values were reported previously in literature. Coleman et al. reported a value of 2460 mL·mg⁻¹ m⁻¹ in different solvents for dispersions of solution exfoliated graphene [Hernandez, 2008]. Lotya et al. reported 6600 mg⁻¹ m⁻¹ for dispersions of graphene that were stabilized by surfactant [Lotya 2010]. Konios et al. reported a value of 3592 mL mg⁻¹ m⁻¹ for graphene oxide dispersion in water [Konios, 2014].

The solubility of G-NBD and G-BBD were determined using the α value obtained. G-NBD showed the highest solubility (250 μg mL⁻¹) in IPA/H₂O compared to 150 μg mL⁻¹ for G-BBD and only 5 μg mL⁻¹ for electrochemically exfoliated graphene.

This compares favourably with reported efforts to enhance the solubility of graphene. Kim et al. reported the exfoliation and dispersion of graphene in water at elevated temperature and obtained a maximum solubility of 6.5 μg mL⁻¹ [Kim, 2015], which is in a close agreement with the value we obtained using electrochemically exfoliated graphene while Wu et al. reported 50 μg mL⁻¹ in ethanol and water mixtures.

Clearly the surface functionalisation of graphene with phenyl moieties as described herein enhanced the solubility of graphene by more than two orders of magnitude.

### Capacitance of Functionalised Graphene

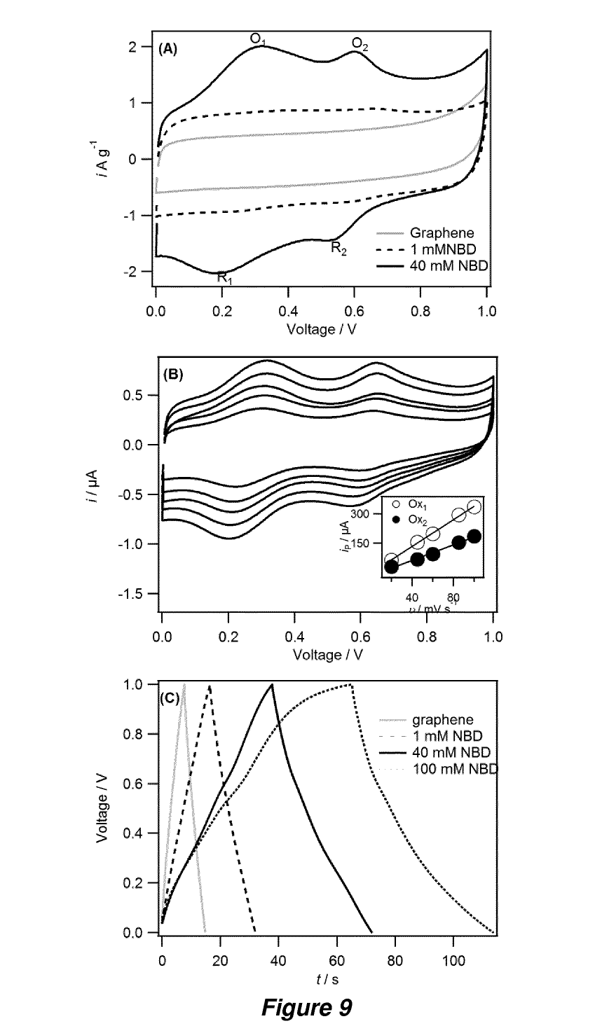

The capacitance of the functionalised graphene produced as described herein was investigated using cyclic voltammetry and chronopotentiometry using symmetrical coin cell architecture (CR2032). The electrodes were made by filtering a known volume of the dispersion on pre-weighed polytetrafluoroethylene (PTFE) membrane where the PTFE act as both an electrode and charge separator. The typical mass loading of each electrode was approximately 0.5 mg cm⁻². FIG. 9A compares the CV obtained at electrodes formed from electrochemically exfoliated graphene and G-NBD in deoxygenated 6M KOH (aq) at 0.1 V s⁻¹. The CV obtained using electrochemically exfoliated graphene electrodes displayed the typical capacitive behaviour with rectangular shape, and no notable faradaic reaction was observed when scanning the voltage up to 0.9 V. In contrast, two well defined transient-shaped oxidation peaks (E_{P}) at 0.3 (Ox₁) and 0.61 V (O₂), along with two corresponding reduction peaks at 0.2 V (R₁) and 0.54 V (R₂) were emerged as functionalisation concentration of NBD increased from 1 mM to 40 mM. The ratio of the anodic peak current, i_{p,a}, to that of the cathodic peak current, i_{p,c}, was approximately 1:1 for each redox couple. In addition, the plot of i_{p,a} increased linearly with increasing scan rate for each redox reactions, confirming the redox reactions are a surface confined process (FIG. 9B).

XPS confirmed that G-NBD contained predominately the aniline-based group and the two redox peaks may attributed to the electrooxidation of aniline. Previous report showed that electrochemical oxidation of aniline may produce a variety of redox couples that were attributed to the formation of nitrene cations, p-aminodiphenylamine, benzidine and degradation of polyaniline films. The presence of faradaic reactions was also more evident in charge-discharge curve when moving from electrochemically exfoliated graphene to G-NBD (FIG. 9C). In electrochemically exfoliated graphene, the charge-discharge curve displayed a symmetrical triangular shape whereas in G-NBD electrodes the curve deviates from the ideal linear shape and two plateaued regions at ˜0.2 and ˜0.6 V were observed, corresponding to the redox reactions.

G-BBD predominately displayed faradaic reactions with a sharp oxidation and reduction current in the potential range studied. This is presumably due to the redox reaction of bromine moieties. Br-functionalised graphene may therefore be less preferred than NBD for applications in supercapacitor technology.

The specific capacitance of each electrode was calculated from the CV at 0.1 V s⁻¹ and a value of 19 F g⁻¹ was obtained for an electrochemically exfoliated graphene-based electrode. The electrodes having functionalised graphene as described herein exhibited much larger specific capacitance than the electrochemically exfoliated graphene-based electrode. The capacitance increases with increasing degree of functionalisation, thought to be due to the contribution from faradaic reactions. Specific capacitance values of 31.4, 56.9 and 71.3 F g⁻¹ were obtained in electrodes that were functionalised in 1 mM, 40 mM and 100 mM NBD respectively.

Although the overall capacitance (double layer capacitance and pseudo capacitance) of the functionalised-graphene based electrodes increased more than three times compared to the electrochemically exfoliated graphene-based electrode, a significant proportion of capacitance increment was obtained from the contribution of faradaic reaction. Closer inspection of the CVs also indicates that the charging current measured using 40 mM G-NBD and 1 mM G-NBD electrodes was not changed in any notable amount. These observations suggest that the functionalisation of graphene preferably occurred at the edge site than the basal plane, and this argument was supported by analysis of powder X-ray diffraction data of restacked functionalised graphene. When powder XRD data were obtained, the (002) peak of G-NBD (at 26.6°) virtually overlaid the position of electrochemically exfoliated graphene demonstrating that functionalisation did not changed the interlayer distance. A change in the interlayer distance would be expected if functionalisation occurred at the basal plane.

Functionalisation and Exfoliation with AQD

### Electrochemical Exfoliation and Functionalisation of Graphite to Produce Functionalised Graphene was Also Performed Using AQD. AQD Refers to Anthraquinone-1-Diazonium.

Electrochemical exfoliation and functionalisation of graphene was performed using a three electrode setup consisting of an isomolded graphite rod/graphite foil working electrode, a silver wire reference electrode and an isomolded graphite rod counter electrode. The effective area of the working electrode that was exposed to the electrolyte was ˜12 cm². The electrolyte was prepared by dissolving 0.3 M CsClO₄ and 15 mM of anthraqunone diazonium (AQD) chloride in anhydrous DMSO. Simultaneous electrochemical exfoliation and functionalisation was performed using chronoamperometry by applying a potential of −4.0 V vs Ag wire for 2 hrs under constant stirring. The exfoliated product was then washed with plenty of acetone and ultra-pure water, and dried under vacuum at 60° C. overnight. The functionalised powder was dispersed in the desired solvent (NMP, water, isopropanol and a mixtures of water and isopropanol alcohol) by sonicating for 30 min. The resulting mixture was centrifuged at 4000 rpm for 30 min, and the supernatant was extracted using a pipette without disturbing the residue.

### Characterisation of the Exfoliated Product

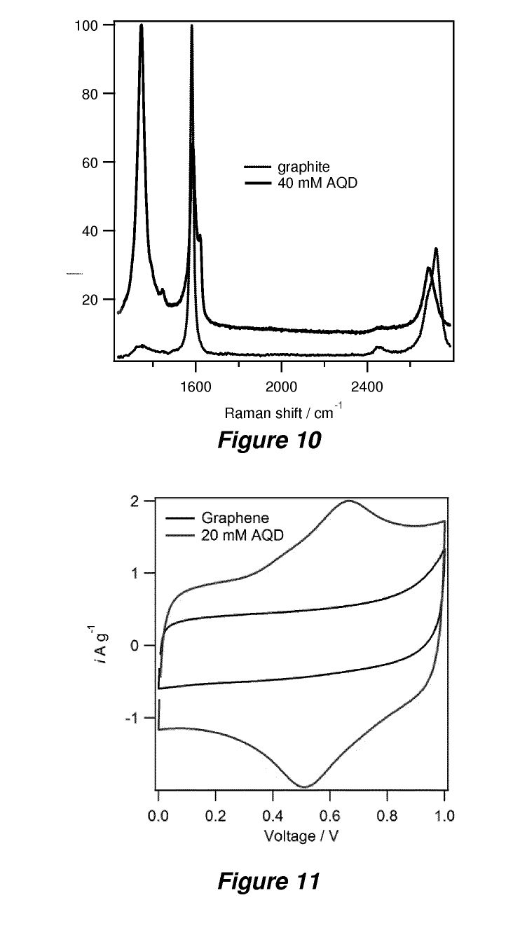

Post electrochemistry characterisation confirmed the formation of few layer functionalised graphene (FIGS. 10 and 11). In FIG. 10 the dotted (lower) line Raman spectrum was obtained for graphite, while the solid (higher) Raman spectrum was obtained for the product at 40 mM concentration. FIG. 11 compares graphene (inner curve) and the AQD-functionalised graphene produced (outer curve). The presence of the peak in the outer curve is the typical signature for AQD.

### Electrochemistry of AQD-Cl

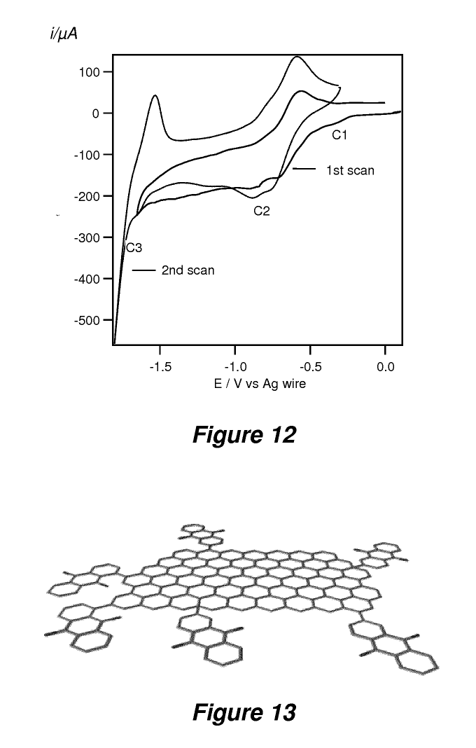

The electrochemical behaviour of ADO was investigated using cyclic voltammetry (FIG. 12). The following reaction sequence was proposed. C₁ was attributed to the formation of the anthraquinone radical which rapidly reacts with graphite surface and C₂ was attributed to reversible proton transfer onto the ADO oxygen moieties. C₃ was due to the intercalation of Cs⁺ indicating that the presence of ADO on graphite surface did not hinder the insertion of Cs⁺.

FIG. 13 shows a schematic illustration of the product. Unlike G-NGB and G-BBD, the G-ADO product was not soluble in water. This is attributed to the hydrophobicity of the ketone moieties in the anthraquinone structure. It was soluble in NMP.

The invention includes the combination of the aspects and preferred features described except where such a combination is clearly impermissible or expressly avoided.

For the avoidance of any doubt, any theoretical explanations provided herein are provided for the purposes of improving the understanding of a reader. The inventors do not wish to be bound by any of these theoretical explanations.

The section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment.

### REFERENCES

The following documents are cited herein. Each document is incorporated by reference herein for all purposes.
Abdelkader, A. M.; Kinloch, I. A.; Dryfe, R. A. W., Continuous Electrochemical Exfoliation of Micrometer-Sized Graphene Using Synergistic Ion Intercalations and Organic Solvents. ACS Appl. Mater. Interfaces 2014, 6, 1632-1639.
Allongue, P.; Delamar, M.; Desbat, B.; Fagebaume, O.; Hitmi, R.; Pinson, J.; Saveant, J. M., Covalent modification of carbon surfaces by aryl radicals generated from the electrochemical reduction of diazonium salts. J. Am. Chem. Soc. 1997, 119, 201-207.
Bissett, M. A.; Kinloch, I. A.; Dryfe, R. A. W., Characterization of MoS2-Graphene Composites for High-Performance Coin Cell Supercapacitors. ACS Appl. Mater. Interfaces 2015, 7, 17388-17398.
Englert, J. M.; Dotzer, C.; Yang, G. A.; Schmid, M.; Papp, C.; Gottfried, J. M.; Steinruck, H. P.; Spiecker, E.; Hauke, F.; Hirsch, A., Covalent bulk functionalisation of graphene.
Greenwood, J.; Phan, T. H.; Fujita, Y.; Li, Z.; Lvasenko, O.; Vanderlinden, W.; Van Gorp, H.; Frederickx, W.; Lu, G.; Tahara, K.; Tobe, Y.; Uji-i, H.; Mertens, S. F. L.; De Feyter, S., Covalent Modification of Graphene and Graphite Using Diazonium Chemistry: Tunable Grafting and Nanomanipulation. ACS Nano 2015, 9, 5520-5535.
Hernandez, Y.; Nicolosi, V.; Lotya, M.; Blighe, F. M.; Sun, Z.; De, S.; McGovern, I. T.; Holland, B.; Byrne, M.; Gun'ko, Y. K.; Boland, J. J.; Niraj, P.; Duesberg, G.; Krishnamurthy, S.; Goodhue, R.; Hutchison, J.; Scardaci, V.; Ferrari, A. C.; Coleman, J. N., High-yield production of graphene by liquid-phase exfoliation of graphite. Nat. Nanotechnol. 2008, 3, 563-568.
Kim, J.; Kwon, S.; Cho, D.-H.; Kang, B.; Kwon, H.; Kim, Y.; Park, S. O.; Jung, G. Y.; Shin, E.; Kim, W.-G.; Lee, H.; Ryu, G. H.; Choi, M.; Kim, T. H.; Oh, J.; Park, S.; Kwak, S. K.; Yoon, S. W.; Byun, D.; Lee, Z.; Lee, C., Direct exfoliation and dispersion of two-dimensional materials in pure water via temperature control. Nat. Commun. 2015, 6.
Konios, D.; Stylianakis, M. M.; Stratakis, E.; Kymakis, E., Dispersion behaviour of graphene oxide and reduced graphene oxide. J. Colloid Interface Sci. 2014, 430, 108-112.
Lim, H.; Lee, J. S.; Shin, H.-J.; Shin, H. S.; Choi, H. C., Spatially Resolved Spontaneous Reactivity of Diazonium Salt on Edge and Basal Plane of Graphene without Surfactant and Its Doping Effect. Langmuir 2010, 26, 12278-12284.
Lotya, M.; King, P. J.; Khan, U.; De, S.; Coleman, J. N., High-Concentration, Surfactant-Stabilized Graphene Dispersions. ACS Nano 2010, 4, 3155-3162.
Mendes, P.; Belloni, M.; Ashworth, M.; Hardy, C.; Nikitin, K.; Fitzmaurice, D.; Critchley, K.; Evans, S.; Preece, J., A novel example of X-ray-radiation-induced chemical reduction of an aromatic nitro-group-containing thin film on SiO2 to an aromatic amine film. Chem Phys Chem 2003, 4, 884-889.
Mu, Y.; Yu, H. Q.; Zheng, J. C.; Zhang, S. J.; Sheng, G. P., Reductive degradation of nitrobenzene in aqueous solution by zero-valent iron. Chemosphere 2004, 54, 789-794.
Niyogi, S.; Bekyarova, E.; Itkis, M. E.; Zhang, H.; Shepperd, K.; Hicks, J.; Sprinkle, M.; Berger, C.; Lau, C. N.; deHeer, W. A.; Conrad, E. H.; Haddon, R. C., Spectroscopy of Covalently Functionalised Graphene. Nano Lett. 2010, 10, 4061-4066.
Saby, C.; Ortiz, B.; Champagne, G. Y.; Belanger, D., Electrochemical modification of glassy carbon electrode using aromatic diazonium salts 0.1. Blocking effect of 4-nitrophenyl and 4-carboxyphenyl groups. Langmuir 1997, 13, 6805-6813.
Silvester, D. S.; Wain, A. J.; Aldous, L.; Hardacre, C.; Compton, R. G., Electrochemical reduction of nitrobenzene and 4-nitrophenol in the room temperature ionic liquid C(4)dmim N(Tf)(2). J. Electroanal. Chem. 2006, 596, 131-140.
Solis-Fernandez, P.; Bissett, M. A.; Tsuji, M.; Ago, H., Tunable doping of graphene nanoribbon arrays by chemical functionalisation. Nanoscale 2015, 7, 3572-3580
Smith, W. H.; Bard, A. J., Electrochemical reactions of organic compounds in liquid ammonia. II. Nitrobenzene and nitrosobenzene. J. Am. Chem. Soc. 1975, 97, 5203-5210.
Stoller, M. D.; Ruoff, R. S., Best practice methods for determining an electrode material's performance for ultracapacitors. Energy Environ. Sci. 2010, 3, 1294-1301.
Sun, Z.; Kohama, S.-i.; Zhang, Z.; Lomeda, J. R.; Tour, J. M., Soluble graphene through edge-selective functionalisation. Nano Research 2010, 3, 117-125.
Zhong, Y. L.; Swager, T. M., Enhanced Electrochemical Expansion of Graphite for in Situ Electrochemical Functionalisation. J. Am. Chem. Soc. 2012, 134, 17896-17899.
WO2012/120264
WO2013/132261
WO2015/019093

1. A method for the production of functionalised graphene and/or functionalised graphite nanoplatelet structures having a thickness of less than 100 nm in an electrochemical cell, wherein the cell comprises:
(a) a negative electrode which is graphitic;
(b) a positive electrode; and
(c) an electrolyte which is ions in a solvent and contains a diazonium species;
wherein the method comprises passing current through the cell to:
(i) effect electrochemical reduction of the diazonium species to produce a functionalising species which undergoes a grafting reaction at the negative electrode; and
(ii) intercalate ions into the negative electrode to effect exfoliation;
wherein (i) and (ii) occur contemporaneously.

2. The method of claim 1, wherein the negative electrode is graphite foil.

3. The method of claim 1, wherein the method comprises passing a current through an electrochemical cell comprising:
(a) a negative electrode which is graphitic;
(b) a positive electrode; and
(c) an electrolyte which is ions in a solvent and contains a diazonium species;
by applying a potential of at least −3 V measured with respect to a reference electrode for a duration of time to produce functionalised graphene and/or functionalised graphite nanoplatelet structures having a thickness of less than 100 nm; and then
isolating the functionalised graphene and/or functionalised graphite nanoplatelet structures having a thickness of less than 100 nm.

4. The method of claim 3, wherein the duration of time is between 1 and 24 h, optionally wherein the duration of time is between 1 and 6 h.

5. The method of claim 3, wherein the applied potential does not vary by more than ±1 V during the duration of time.

6. The method of claim 1, wherein the electrolyte comprises substantially only one type of cation and comprises a diazonium species.

7. The method of claim 1, wherein the electrolyte comprises a cation selected from Li⁺, Cs⁺ and tetraalkylammonium.

8. The method of claim 1, wherein electrolyte comprises ions in a solvent selected from dimethyl sulfoxide, N,N-dimethylformamide, and N-methyl-2-pyrrolidone.

9. The method of claim 1, wherein the diazonium species is of formula R—N₂⁺, wherein R is optionally substituted aryl or heteroaryl.

10. The method of claim 9, wherein the diazonium species is selected from:

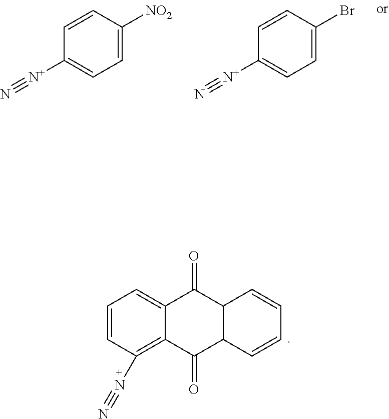

11. The method of claim 1, wherein the diazonium species has a counter ion which is tetrafluoroborate.

12. The method of claim 10, wherein the diazonium species has a counter ion which is tetrafluoroborate.

13. The method of claim 8, wherein the diazonium species is selected from:

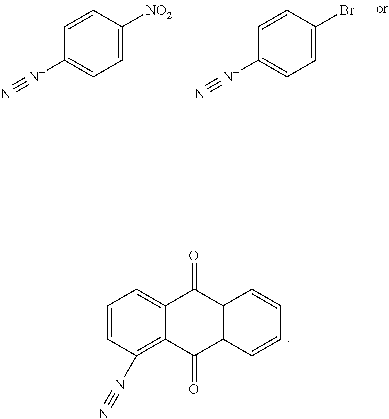

14. The method of claim 12, wherein the diazonium species has a counter ion which is tetrafluoroborate.
